(19) United States
(12) Patent Application Publication
(10) Pub. No.: US 2001/0032120 A1
(43) Pub. Date: Oct. 18, 2001

(54) Individual call agent productivity method and system

(76) Inventors: Robert Oden Stuart, Indianapolis, IN (US); Scott Patterson Stuart, Atlanta, GA (US); Deborah S. Hanna, Bloomington, IN (US)

Correspondence Address: Michael B. McNeil, Liell & McNeil, P.O. Box 2417, Bloomington, IN, 47402, US

(21) Appl. No.: 09/813,566

(22) Filed: Mar. 21, 2001

Related U.S. Application Data
(60) Provisional application No. 60/190,941, filed on Mar. 21, 2000.

(51) Int. Cl. G06F 17/60

(52) U.S. Cl. 705/11

(57) ABSTRACT

A method of evaluating call agent efficiency is disclosed that includes the step of collecting agent call handling data for at least one call agent. Agent cost data for the at least one call agent is then collected. A cost based performance indicator for the at least one call agent is determined, at least in part as a function of the agent call handling data and the agent cost data.

### RELATION TO OTHER APPLICATION

This application claims priority from pending provisional application No. 60/190,941, filed Mar. 21, 2000, with the same title for any commonly disclosed subject matter.

### TECHNICAL FIELD

This invention relates generally to a method of evaluating call agent efficiency, and more particularly to a method and system of evaluating call agent efficiency utilizing a cost based performance indicator.

### BACKGROUND ART

Essential to the successful management of the call-agent function is the ability to monitor and assess the performance of individual call agents. Typically, within call centers, a telecommunications server is utilized to distribute calls to agents. These servers are capable of handling both the distribution of incoming calls to agents as well as the distribution of outbound calls made by agents. As part of this distribution process, the call distributor may possess some type of capability to monitor and report on certain quantitative and qualitative aspects of the agent's call handling performance.

In an attempt to assess individual and aggregate call agent performance, reports generated by current systems often rely on various types of agent performance measures monitored by the server, such as the number of calls handled by an agent, the average work time per call of the agent, and similar measures. Many current systems rely heavily on the concept of average work time (AWT) to compare performance among call agents. AWT refers to the average amount of time that an agent spent handling each call. While AWT could be expressed in a number of ways, it is typically expressed as an absolute ratio between two performance variables that are monitored for the agent or group of agents. This absolute ratio would be calculated dividing the total amount of time an agent or agents spent handling calls by the total number of calls handled by the particular agent or agents. Alternatively, this type of agent performance measure could be expressed as a relative ratio between two performance variables that are monitored for the agent or group of agents. An example of the relative ratio would be Percent AWT (%AWT). In calculating the %AWT, an agent's AWT is compared to an average of an overall group's AWT. This % AWT performance measure is calculated by dividing the agent's average work time per call by the average work time per call of an entire group of agents.

Although this % AWT performance measure may be useful in managing agent practices in certain limited situations, the % AWT, as with many other commonly monitored performance measures, does not accurately reflect the true performance of the individual agent. Indeed, use of AWT alone to evaluate call agent performance can lead to encouragement, and even reward, for poor performance. For instance, it has been found that call agents can manage or lower their AWT by purposefully cutting off customers prematurely and by utilizing many other poor operating practices, such as supplying incorrect, but quickly accessible information. In addition, call attendant performance may range more than 50% from the lowest to best performers. Actions from low performing agents can be expensive to a call center organization. In fact, one particular nationwide, directory assistance call center study suggested that the cost impact of the bottom 10% of the call agents was approximately $1,000,000 in lost productivity.

In addition to the use of agent performance monitoring and evaluating agent techniques that do not most accurately reflect true agent performance, current agent force management systems monitor and report these results in an inefficient manner. For instance, under the current systems, agent call-handling data is collected in a ‘census’-style approach. In other words, all agent call handling data is collected and then stored for a period of time. This agent call handling data, which can be quite extensive, is then analyzed and used to generate printed reports at a later point in time. In a typical call center environment, management must sort through a myriad of these reports when attempting to find some meaningful measure of an agent's performance. Once identified, whether or not the measure accurately reflects the agent's true performance, these performance measures are utilized to encourage or modify certain agent practices. Further, there is often very little meaningful feedback provided to the agent. What feedback that may be given to the agent may come from a manager or supervisor who has little time to interpret the many reports received and/or who may not have the expertise necessary to fully understand the agent's true level of productivity. Thus, there is little or no opportunity for an agent to view, interpret and understand for himself or herself the consequences of the agent's operating practices.

The present invention is directed to overcoming one or more of the problems as set forth above.

### DISCLOSURE OF THE INVENTION

In accordance with one aspect of the present invention, a method of evaluating call agent efficiency includes the step of collecting agent call handling data for at least one call agent. Agent cost data for the at least one call agent is then collected. A cost based performance indicator for the at least one call agent is determined, at least in part as a function of the agent call handling data and the agent cost data.

In accordance with another aspect of the present invention, a system for evaluating call agent efficiency includes a means for collecting agent call handling data for at least one call agent. Also provided is a means for collecting agent cost data for the at least one call agent. A means for determining a cost based performance indicator for the at least one call agent is also provided, wherein the cost based performance indicator is a function of said agent call handling data and said agent cost data.

In one preferred aspect of the present invention, an agent management information system is provided that measures and analyzes agent productivity utilizing a statistically-valid, random sampling of agent call handling events.

In another preferred aspect of the present invention, a standardized measurement system for analyzing agent productivity is provided.

In yet another preferred aspect of the present invention, a cost-based measurement system for analyzing agent productivity is provided.

In still another preferred aspect of the present invention, an agent management information system is provided that is capable of reporting information to both supervisors and agents in real-time utilizing a user-friendly, graphical interface.

In yet another preferred aspect of the present invention, an agent management information system is provided that is capable of producing both standardized reports and exception reports, both types of which may be produced in real time or historical mode.

### BRIEF DESCRIPTION OF THE DRAWINGS

FIG. 1 is a schematic representation of a call agent performance system according to the present invention;

FIG. 2 is a schematic representation of a collection module, an analysis module and a reporting module for use with the call agent performance system of FIG. 1;

FIG. 3 is a flow chart of the collection module, analysis module and reporting module of FIG. 2;

FIG. 4 is an example of a written report generated utilizing the present invention; and

FIG. 5 is an example of a graphical report generated utilizing the present invention.

### BEST MODE FOR CARRYING OUT THE INVENTION

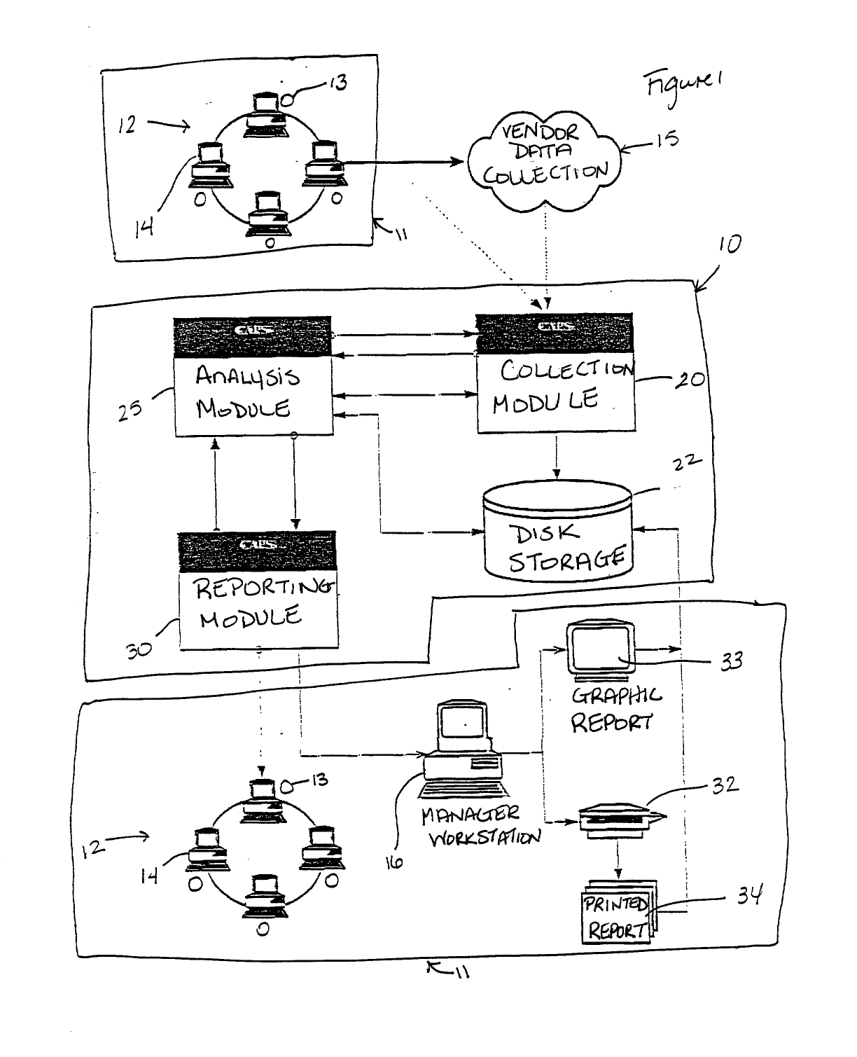

Referring now to FIG. 1 there is shown a schematic representation of a call agent performance system 10 according to the present invention. While one embodiment of system 10 has been illustrated, it should be appreciated that a number of modifications and substitutions could be made to system 10 without departing from the scope of the present invention. Call agent performance system 10 is preferably utilized to evaluate the performance of a call agent team 12, as well as the individual performance of the one or more call agents 13 included in call agent team 12 and positioned at each call agent workstation 14. Preferably, data relating to call agent team 12 and call center 11 is collected and stored in one or more vendor stat packs 15. Examples of data collected by stat pack 15 include number of calls received by call center 11, number of calls directed toward call agent team 12, number of calls directed to each agent 13, origin of incoming calls, time of day and date. It should be appreciated that stat pack 15 could be any conventional stat pack commonly used in the art. For instance, stat pack 15 could be a real time database that tallies the total incoming calls, total outgoing calls and total calls taken by each call agent 13. In addition, stat pack 15 could include the classification of each call received by call center 11, such as calls requiring multiple searches and calls in which no search was performed.

As previously indicated, call agent performance system 10 is preferably operably connected to call agent team 12 and vendor stat pack 15. Call agent performance system 10 collects both agent call handling data and call agent cost data for each call agent 13. Call agent performance system 10 then utilizes this data to determine a cost based performance indicator for each call agent 13. In addition, call agent performance system 10 can also use this data to determine a cost based performance indicator for call team 12, call center 11, or for any combination of multiple call teams and/or call centers corporate wide. Call agent performance system 10 preferably has the capability to collect needed call handling data and agent cost data, analyze this data to determine one or more cost based performance indicators, and then to report the results. These three preferred functions of call agent performance system 10 have been illustrated in FIG. 1 as collection module 20, analysis module 25 and reporting module 30. However, it should be appreciated that these functions need not be carried out by three distinct hardware or software components. Rather, collection module 20, analysis module 25 and reporting module 30 have been illustrated separately to highlight the three functions that the preferred embodiment of call agent performance system 10 is capable of performing.

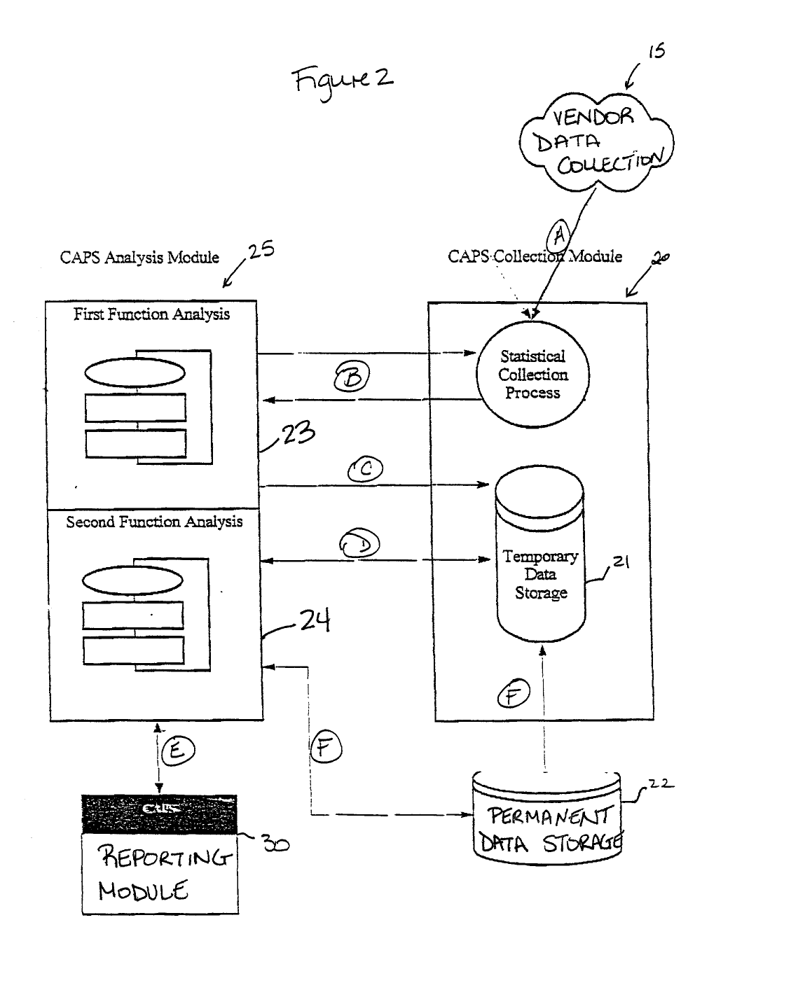

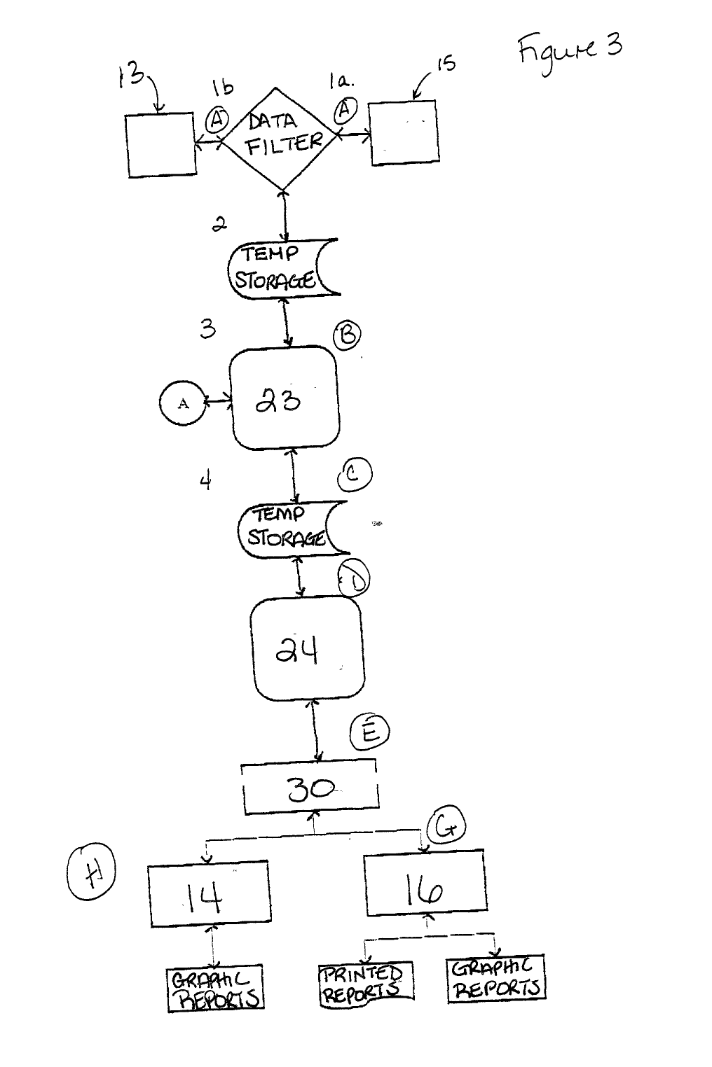

Referring now in addition to FIGS. 2 and 3, the interrelation between collection module 20, analysis module 25 and reporting module 30 has been illustrated. Collection module 20 preferably interfaces with the one or more vendor stat packs 15, or other existing data collection systems, to collect agent call handling data, such as that data previously mentioned (Step A, FIGS. 2 and 3). While this data could be collected using any one of a number of methods, in the preferred embodiment, a sample of this data is preferably taken using a statistical sampling method, such as a random Nth sampling technique. Thus, according to this preferred embodiment of the present invention, data relating to incoming calls of a particular call type that are distributed to a particular agent is randomly collected by collection module 20. Existing accepted statistical processes are then used by collection module 10 to determine the number, or sample size, of each type of call handled by a particular agent required in order to achieve a particular confidence level. Once the initial requisite sample size has been collected for a particular agent and call type to allow for a particular level of confidence in the resulting statistical analysis, statistical reports may be generated by reporting module 30, as discussed below, at various points throughout the data collection and storage process.

Returning to collection module 20, agent call handling data will preferably continue to be collected once the minimum confidence level has been achieved. Because agent call handling data is continuously being collected, the sample size will continue to increase. It should be appreciated that this in turn will increase the confidence level of the collected data. In other words, as the amount of data collected increases for call agent 13, the likelihood of analysis of that data generating an accurate, or near accurate, picture of the performance of call agent 13 will also increase, at least up to a point. Thus, the reliability of the results achieved, and therefore their likelihood of contributing to the determination of an accurate indicator of performance for each call agent 13, can be increased. However, it should be appreciated that once a certain amount of agent call handling data has been collected for a particular call agent and/or call type, the reliability of the results will no longer increase. In other words, the sample size can reach a level where the results of analyzing the data will be no less reliable than if the sample size were increased. However, it should also be appreciated that it is preferable for current agent call handling data to continuously be collected in order for an up-to-date, or real time, performance indicator to be determined.

Therefore, in the preferred embodiment of the present invention, once a maximum sample size has been attained, collection module 20 will continue collecting agent call handling data and adding it to the sample while simultaneously removing the oldest agent call handling data record from the sample. In other words, for the preferred embodiment of the present invention, agent call handling data is preferably collected, stored for a period of time and then replaced. While old agent call handling data is continuously removed from the sample, it should be appreciated that this information may not be deleted. For instance, returning to FIG. 2, agent call handling data that is currently included in the sample could be stored in a temporary data storage location 21. As old data is removed from temporary data storage location 21, it can be saved in an alternate location, such as permanent data storage location 22, for historical recording or other purposes.

As indicated, while the preferred embodiment of the present invention utilizes random sampling techniques to collect agent call handling data, this is not necessary. For instance, instead of utilizing a random sampling technique, agent call handling data regarding every Nth call could be collected. Alternatively, all agent call handling data relating to one or more call agents 13 and/or one or more call types could be collected by collection module 20. However, collection of agent call handling data using a sampling technique is preferable for a number of reasons. First, the amount of platform resources needed to collect and store a sample of the available agent call handling data is much less than that used when all available agent call handling data is collected and stored. In fact, current system resources used for agent call handling data collection and storage could be reduced as much as 30% when only a sample of the data is used. It should be appreciated that with less system resources dedicated to collection and storage of agent call handling data, system response time can increase. In addition, when only a sample of available data is collected, the effect of lost data is greatly diminished. It should be appreciated that the reliability and usefulness of performance results generated by systems utilizing all available agent call handling data can be diminished when an amount of stored data is lost, such as in the case of an unplanned system shutdown. Thus it is believed that data collection and storage based on a sampling method can increase system efficiency while contributing to the determination of a more reliable cost based performance indicator for the call agents, the call team and the call center.

Returning now to FIG. 2, agent call handling data that is collected by collection module 20 is preferably analyzed by analysis module 25. While a variety of analysis methods are available, the method utilized by analysis module 25 to analyze the collected agent call handling data can be thought of as a two step process. This preferable two step process has been illustrated in FIGS. 2 and 3 as the analysis module first function 23 and the analysis module second function 24. The task of analysis module first function 23 is to retrieve data from collection module 20 and convert it into data sets and elements to be analyzed (Step B, FIGS. 2 and 3). The converted data sets and elements are then preferably stored in temporary storage location 21 for use by analysis module second function 24 (Step C, FIGS. 2 and 3). The stored data sets and elements are then retrieved by analysis module second function 24 (Step D, FIGS. 2 and 3), which interacts with reporting module 30 to analyze the data sets and/or elements as a function of specific requests received from reporting module 30 (Step E, FIGS. 2 and 3). In other words, analysis module first function 23 gathers the data collected by collection module 20 and performs one or more calculations to convert the raw data into useful data, while analysis module second function 24 organizes the useful data to be distributed by reporting module 30.

In the preferred embodiment of the present invention, the manner in which raw data is converted and analyzed, as well as the manner in which converted data is organized, is determined by two types of management input constraints. First, flexible standards can be input by management to be applied to the agent call handling data during the first function of the analysis module to create all necessary data sets and elements. These standards are flexible because management can decide what criteria are important for evaluation, and then input only these criteria as standards. The present invention preferably calculates the standard for call center 11 and/or each individual call agent 13. These flexible standards could include any of a number of criteria, such as range of performance, daily sessions and call type, among many others. The standard may also be a simple average, such as the mean or median, or a high performing norm (HPN), such as the 90^{th} percentile. Standards may be established for session of the day, Saturday, Sunday or Holidays. Further, the present invention can also preferably calculate the standard down to intra call components. Second, flexible thresholds, can be input by management and applied to agent call handling data during the second function of the analysis module to generate subsets of data for the reporting module. The flexible thresholds are preferably the parameters set by management to trigger the generation of real-time exception reports. These flexible thresholds could be statistically significant values such as a High Performing Norm (“HPN”), Average, ‘X’ percentile, or “X” standard deviations. In addition, the thresholds are indeed flexible because they can differ at all levels of reporting detail. For instance, the flexible thresholds for individual call agents 13 could be different than those for call center 11. Further, the flexible thresholds can vary between and among call agents 13 to allow for the probable disparity in productivity between and among new and experienced operators.

Returning now to call agent performance system 10, analysis module first function 23 determines a cost-based performance indicator that is preferably based on standard measurements to facilitate evaluation of call agents 13. The agent cost data used for the determination of the cost-based performance indicator could include salary only, or a combination of salary, benefits, training cost, etc. for each agent 13. By including a cost consideration when evaluating each call agent 13, a more accurate assessment of the true productivity or performance can be determined than with use of current agent evaluation methods. Recall that current agent evaluation methods rely upon average work time (AWT) to measure the performance/productivity of call agents 13. In other words, performance of each call agent 13 is measured by the average amount of time that is spent on each call. Call agents 13 having a low AWT are considered to be model agents, while those having a higher AWT are considered to be underachievers.

Thus, the present invention overcomes the problems inherent in the current call agent performance evaluation methodology by providing a method of evaluating call agent performance that is determined, in part, by cost data for the individual agent. In the preferred embodiment of the present invention, this cost data is used in combination with agent call handling data to calculate a standardized cost based performance indicator for call agent 13. By including cost as a factor for evaluating performance, management can get a more accurate representation of how cost is being distributed throughout the call center.

The present invention therefore provides a method of calculating a cost per standard work unit (C/SWU) to be used to evaluate the performance of call agents. The standard work unit could be any unit of time, such as seconds, minutes, hours, or even days or weeks. Preferably, the C/SWT is calculated using the following formula:

C/SWT=C/(Total Calls*(SWT/X)) (1)

Where C is the cost of the agent per unit of time and total calls corresponds to the total number of calls taken by the call agent during the period of time in question. SWT is the standard work time, as calculated below, and X corresponds to the constant required to convert the standard work time into the desired time units. For instance, to convert a SWT from seconds to minutes, in order to calculate a standard work minute, X is 60. Preferably, SWT is calculated using the following formula:

SWT=T*%O (2)

Where T is the work time and %O is the percent occupancy. When this equation if used with to calculate the C/SWT for individual call agents, percent occupancy is replaced by the percent of work time that the call agent answered calls. Thus, to determine the SWT for a call agent that answered calls 100 while working for 90% of an hour, equation (2) would yield:

SWT=3600*0.9=3240/100=32.4≧ (3)

In other words, the call agent worked 3240 seconds during the hour in question and answered 100 calls, resulting in a SWT of 32.4″. Thus, for call agent 13 having a cost per hour of $13.00 and answering 100 calls per hour, the individual C/SWM for that agent would be calculated as:

C/SWM=13.00/(100*(32.4/60))=$0.24 (4)

Returning to equation (1), it should be appreciated that the cost of a call agent can be determined in a number of ways. For instance, agent cost per period of time could be defined as the percent of the agent's salary earned for that time period. Alternatively, agent cost per period of time could be defined as the percent of the agent's salary earned for that time period as well as a percent of benefits, paid holiday time, paid training time, etc. attributable to the agent. The present invention does not seek to limit the factors that contribute to the cost for each agent. Rather, the cost utilized for calculation of the C/SWT is intended to be the sum of all call agent cost data that is deemed important to the user.

In addition, while the cost based performance indicator of the present invention has been illustrated as determining the C/SWT of a single call agent 13, it should be appreciated that the C/SWT could also be determined for call team 12 or even call center 13. Recall equation (1), used to calculate C/SWT is:

C/SWT=C/(Total Calls*(SWT/X)) (1)

When utilized to determine C/SWT for a group of call agents 13, such as for call team 12 the components of this equation are determined as follows. Preferably, the cost, C, utilized for determination of C/SWT for call team 12 is the variable labor cost, or the average hourly wage rate for each call agent 13 included in call team 12. The total calls utilized for calculation of C/SWT is equivalent to the total number of calls answered by members of call team 12. Finally, SWT is preferably calculated utilizing the percent occupancy for call team 12.

As indicated, the standardized cost based performance indicator calculated by the present invention is also based on the number of calls taken by call agent 13 during the time period in question. While call agent 13 could reduce AWT by responding to calls more efficiently, there are also a number of ways that each call agent 13 could reduce AWT that are not preferable from the management standpoint. For instance, if call agent 13 handles a particularly long call, he or she might disconnect the next several calls in an attempt to lower the average. These immediate disconnect calls are commonly referred to as “No Voice, No Answer” (NVNA) calls. It should be appreciated that a high number of NVNA calls will not help call center 11, and may in fact hurt it. For instance, if call center 11 is a directory assistance or information call center, this behavior can create customer dissatisfaction, causing potential callers to go elsewhere for their information, if possible. Alternatively, if call center 11, or call agent team 12, is responsible for selling products or services, the results could mean lost sales, and therefore lost money in the form of revenue, for the company.

While the present invention preferably utilizes the number of calls answered by each call agent 13 as one factor in determining a cost based performance indicator for the call agent to allow for a complete assessment of agent productivity, concerns regarding the use of this factor are still valid. Thus, the preferred embodiment of the present invention includes a number of features to address this concern. First, a quantitative indicator of customer service provided and/or sales generated for each call agent 13 is preferably included in the printed results generated by reporting module 30. Thus, if call agent 13 is on a sales call agent team 12, a quantitative sales indicator can be included in the printed reports. For instance, the data generated for call agent 13 could include the total dollar amount sold by call agent 13, the number of product/service units sold by call agent 13, or any other useful quantitative indicator of sales. Alternatively, if call agent 13 is a member of a directory assistance call team 12, a quantitative indicator of customer service, as perceived by persons calling into call team 12, could be included in the printed report. In addition, the number of found listings could be utilized as a “revenue” indicator for a directory assistance call agent 13. Further, data such as number of calls registered as found can be included as higher valued calls than NVNA calls in the printed reports generated by reporting module 30, as discussed in greater detail below.

Returning to call agent performance system 10, once the call agent performance data and the agent cost data has been analyzed by analysis module first function 23 and made available to reporting module 30 by analysis module second function 24, one or more reports can be generated. Preferably, reporting module 30 interacts with analysis module 25 to produce the one or more reports, both graphical and printed, based upon management specified criteria. In addition, these reports could also be recorded digitally for historical purposes. Because the preferred embodiment of the present invention preferably generates performance analysis results in a graphical form, areas of management concern can be more easily identified than with the use of current, printed only, reports. Further, the present invention also preferably provides each call agent 13 with the ability to view graphical performance reports as well. Call agents 13 could view graphical reports at their own workstation, or at a workstation that is set aside solely for the viewing of performance reports by call agents. In addition, the graphical reports could be available on demand by each call agent 13, or only when a supervisor determines that call agent 13 should view an evaluation of his or her performance.

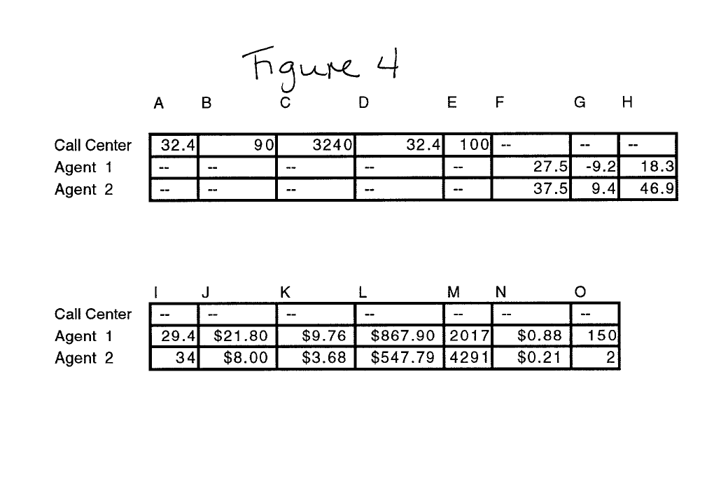

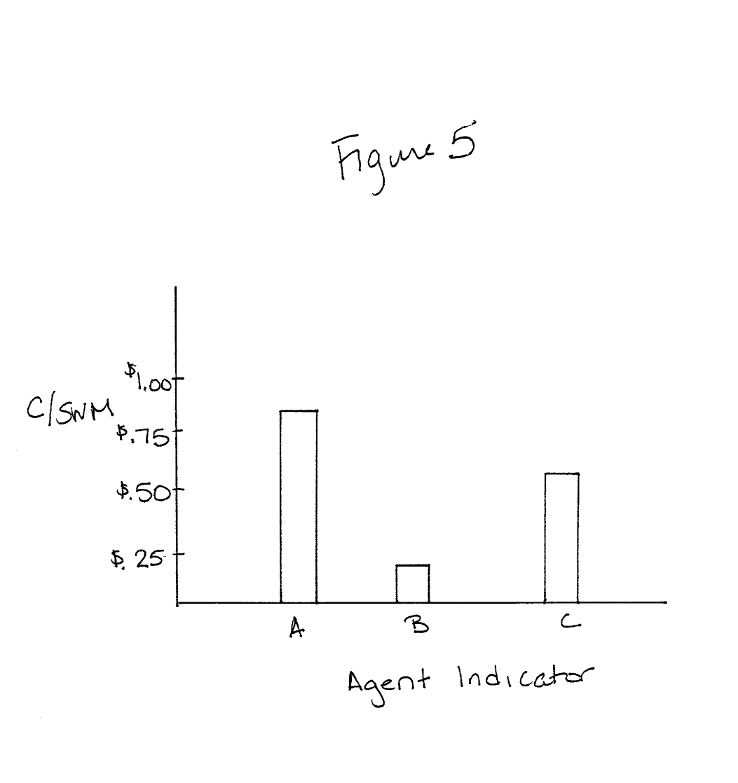

As illustrated in FIG. 4, call agent performance system 10 preferably has the capability to generate one or more printed performance reports, as well as a number of graphical reports (FIG. 5). While one printed report format has been illustrated in Figure 4, it should be appreciated that the printed report could be tailored to meet the needs of the recipient. For instance, while the report has been illustrated summarizing data and results for a number of individual call agents 13, results could instead be reported for one or more call agent teams 12 and/or one or more call centers 13. Returning to FIG. 4, the results included in each column, as well as the manner in which they were determined, will be discussed in turn. Columns A-E provide information specific to call center 11, including the SWT of call center 11, the percent occupancy of call center 11, work seconds per board hour, call center 11 AWT average and the calls per board hour for call center 11. The remaining columns, however, provide information relating to each individual call agent, as discussed below.

Column F provides the expected work hours for Agents 1 and 2 for a given week. It should be appreciated that an agent might not be at work at all expected times, such as due to an absence, and that not all hours spent at work by an agent are productive hours. For instance, an agent might put their workstation in a “make-busy” condition for a period of time, or they might begin working late or leave early one or more days. Further, it should also be understood that an agent might work overtime during the week in question. Similarly, an agent might begin working early or leave late on one or more days. Thus, provided in Column G is the time adjustment that must be applied to the work time in Column F to arrive at the productive hours for Agents 1 and 2, indicated in Column H.

Provided in Column I is the individual SWT for each Agents 1 and 2, as determined utilizing the present invention. In addition, compensation information regarding salary per hour and BVH cost per hour (Benefits, Vacation and Holiday) for Agents 1 and 2 is provided in Columns J and K, respectively. This compensation information, along with the total number of hours worked by each agent, as opposed to the number of productive hours for each agent, contributes to the total cost for the week for Agents 1 and 2, as indicated in Column L. In addition, the total number of calls answered by Agents 1 and 2 for the week in question is indicated in Column M. The C/SWM for Agents 1 and 2 has been calculated from equation (1) above utilizing the relevant information and has been included in Column N. As indicated, it should be appreciated that Agent 2 is over fours times more cost effective than Agent 1. This difference is due not only to the lower compensation attributed to Agent 2, but also to the higher number of productive hours of Agent 2. While it is true that Agent 2 started with a higher number of scheduled, or base, work hours than Agent 1, note that the net work time adjustments for Agent 2 were positive, resulting in a high number of productive hours for the week. This can be compared to Agent 1, whose base work time was reduced by nearly ten hours, or almost one third, to reflect his or her true total productive hours.

Returning to FIG. 4, in addition to the cost based indicator calculated and provided in Column N, the printed report may also preferably include columns detailing number and/or percentage of various types of calls. For instance, as illustrated in Column O, the number of NVNA calls has been provided for each call agent. This information, when viewed in conjunction with the C/SWM for the agent, can help provide a more complete indication of the performance of the agent. For instance, as described above, one factor used to calculate the C/SWM is the number of calls answered by call agent 13 over the given time period. Thus, it should be appreciated that having a lower AWT, which will allow call agent 13 to answer more calls, can contribute to a lower C/SWM. However, if call agent 13 is lowering their AWT, and thus inflating the number of calls taken, by disconnecting a disproportionately large amount of calls, this will be reflected on the printed report. Therefore, management will be able to locate those call agents 13 who are lowering their C/SWM by intentionally disconnecting one or more incoming calls. It should be appreciated that while a practice such as this might allow call agent 13 to manipulate the numbers to appear to have a low AWT, however, because the standard could allow credit only for certain types of calls handled, the C/SWT would reflect this poor productivity. In addition, the high number of calls per hour would raise a flag to management that a closer look at the true productivity of the call agent was needed.

In addition to the information included in the FIG. 4 printed report, data relating to alternate call type that could be useful to track when evaluating call agent performance. One such call type is a “No search” call. This type of call would be important to track when call agent 13 is working for a directory assistance call center, or another call center 11 in which information is disseminated. Thus, if call agent 13 has a relatively high number of calls with no searches, a supervisor might inquire as to why no searches were performed to determine the true productivity of call agent 13. Another potential indicator of call agent performance could include the number of calls answered by call agent 13 that required multiple searches. It should be appreciated that a relatively high number of multiple search calls could indicate that call agent 13 needs more training because he or she is having difficulty finding the information requested by callers. Further, while not illustrated, it should be appreciated that reports including totals for other call types, such as audio response calls or miscellaneous calls, could also provide a more detailed determination of the performance of call agent 13.

Referring now to FIG. 5, call agent performance system 10 also preferably has the capability to generate graphical reports, in addition to the printed reports described above. While the printed reports would preferably be available to management only, graphical reports, such as that illustrated in FIG. 5, are preferably available for both management and each individual call agent 13. In addition, while the graphical report generated by call agent performance system 10 has been illustrated as a bar graph, it should be appreciated that a number of graphical formats could be utilized to display information for management and call agents 13 in a useful manner. Returning now to FIG. 5, the cost based performance indicator Agent 1 has been illustrated as Bar (A).

In addition to the C/SWM indicator for Agent 1, two other cost based performance indicators have been included on FIG. 5. As indicated previously, in addition to illustrating the C/SWT of a single call agent 13, it might also be useful to include the cost based performance indicator for one or more other call agents 13. Thus, the graph of FIG. 5 includes the cost based performance indicator for Agent 2, represented by Bar (B). In addition, the graph of FIG. 5 includes an indicator of the past performance of Agent 1. Thus, Bar (C) represents the C/SWM for Agent 1 calculated at some period in the past, such as the lowest attained C/SWM of Agent 1. It should be appreciated that the graphical report generated by reporting module 30 could include only one of these additional cost based performance indicators. The graphical report generated by reporting module 30 could also include a cost based performance indicator for all of call team 12 or call center 11. Further, it might be preferable to include less cost based performance indicators than illustrated, cost based performance indicators based on other criteria, or no cost based performance indicators in addition to the present C/SWT of the particular call agent 13. As with several other aspects of the present invention, the amount and type of information included in the graphical report generated by reporting module 30 is preferably determined by the needs of the individual call team 12 or call center 11.

Returning to reporting module 30, reports other than those illustrated herein could also be generated, such as standard reports and/or exception reports. Standard reports, either automatically generated or those generated on demand, allow for a comparison of the actual performance of call agent 13, with standards, such as HPN call agents or past performance of the individual call agent. One benefit to the generation of this type of report is the illumination of opportunities for improvement of call agent performance. For example, by applying statistical techniques to the data collected for a particular call agent 13, performance of call agent 13 could be compared to the standard performance of other call agents. For instance, this type of report could indicate whether the number of calls handled by call agent 13 which required multiple searches of the directory database was statistically greater than would be expected based on the standard productivity of other call agents. Other possible standard reports could include a statistical evaluation of the performance of call agent 13 regarding the number of miscellaneous calls handled and/or the number of calls call agent 13 released to the audio response unit. Further, it should be appreciated that the performance of call agent 13 could be compared with the standard productivity of other call agents and analyzed with respect to every possible call type. Once again, the information included on a standard report, if generated, would be dependent upon those factors deemed important by management.

In addition to these standard reports, reporting module 30 is also preferably capable of generating exception reports. In the preferred embodiment of the present invention, these reports would be generated when the performance of call agent 13 exceeds one or more statistical thresholds. For example, an exception report could be generated when the number of calls requiring multiple searches by call agent 13 exceeds a predetermined number. Similarly, an exception report could be generated when the number of NVNA calls, or those calls having no search performed by call agent 13 exceeds a predetermined number. Thus, it should be appreciated that an exception report could be generated when some aspect of the performance of call agent 13 exceeds some pre-determined threshold by a statistically significant value, such as by a number of standard deviations. Therefore, exception reports could evaluate other statistically significant events indicative of the performance of call agent 13, such as excessive time in which call agent 13 did not answer calls, an unusual mix of call types, a statistically high number of either positive or negative customer service feedback, or statistically high or low sales data.

In addition to the above described features, the call agent performance system of the present invention is also preferably capable of determining a projected C/SWT based upon hypothetical call agent handling data and/or hypothetical agent cost data. For instance, management could utilize this feature to determine the most cost effective combination of call agents 13 to be scheduled for one or more shifts. Here, management could input use trends, such as the average number of calls and/or type of calls that are received during a given period of time, and input this information as the hypothetical call agent handling data. In addition, the cost of each call agent 13, using those factors deemed important by management, could then be input as the hypothetical agent cost data. This information could then be input for different combinations of call agents 13 to determine the most cost effective group of call agents 13 for that time period. Alternatively, management could use this feature as a motivational tool for one of more call agents 13, or to set goals for one or more of the call agents 13. For instance, a supervisor could show call agent 13 their current C/SWM, as well as their projected C/SWM if the agent handled some number of additional calls. This projected C/SWM could be reported to call agent 13 as a goal toward which to work.

In addition to those features of the present invention that have been described, it should be appreciated that the performance evaluation method disclosed herein could be used in conjunction with one or more call agent systems to further improve the productivity or performance of each call agent 13 or call agent team 12. For instance, the present invention could be used in conjunction with the call distribution method disclosed in pending application Ser. No. 09/366,114, entitled “METHOD AND APPARATUS FOR AGENT FORCING AND CALL DISTRIBUTION FOR LARGE TEAM CALL SERVICING.” Disclosed therein is a method of assigning call agents 13 to one or more teams that are arranged in a hierarchy. Calls are then distributed to call agents 13 based upon the call team 12 to which they are currently assigned. Thus, management could use the cost based performance indicator determined by the present invention as a factor in determining which call agents 13 are assigned to which call teams 12.

In addition, the present invention could also be used in conjunction with the feedback collection and monitoring system disclosed in pending application Ser. No. 09/636,056, entitled “SYSTEM AND METHOD FOR PROVIDING A SERVICE TO A CUSTOMER VIA A COMMUNICATION LINK.” Recall that the preferred embodiment of the present invention includes service data for determination of the cost based performance indicator for each call agent 13. Therefore, service feedback could be collected in the manner disclosed therein, and then stored for use with the present invention. In this alternative, the present invention could be configured to retrieve service data for each call agent 13, preferably by sampling, to be used when determining the cost based performance indicator for each call agent 13. As before, any positive service feedback could be given a positive numerical value, while any negative feedback could be given a negative numerical value. It should be appreciated, however, that any suitable method for collecting call agent service data could be utilized in combination with the present invention.

The cost based performance indicator of the present invention provides a measurement of call agent performance that can allow for a more accurate assessment of call agent performance than can be determined with current performance analysis methods. Existing performance analysis systems, such as those relying extensively on the agent AWT, measure the wrong item, apply it to the wrong level or do not measure the important items at all. The C/SWT can reflect any change in performance, either positive or negative, that affects the overall determinants of cost, namely call traffic volume, price of labor, quantity of labor, or the productivity of labor. The C/SWT may be expressed in almost any time unit appropriate to management needs. For instance, while the C/SWT has been expressed in minutes herein, it should be appreciated that other time units, such as standard seconds or standard hours, could be utilized. The C/SWU may also be calculated using almost any type of cost input appropriate to management needs, such as the salary of an individual call agent, or the total compensation received by the call agent. Additionally, the desired type of cost input may be differentiated by level of cost detail. The flexibility provided by the level of cost detail allows the C/SWT to be calculated for an individual call agent, a call agent team, an entire call center, a base unit comprised of multiple call centers, or the entire call servicing system. Further, the novel graphical reports generated by the present invention preferably utilize standard statistical techniques to graphically represent significant statistical deviations in productivity among operators, groups or call service centers through the use of bell curves, trended data analysis, and other statistical techniques.

Therefore, use of the present invention can reduce call center expense by providing management with the tools needed to identify true call agent performance. For instance, it should be appreciated that use of AWT, as used by most current evaluation system, can yield results that are somewhat helpful, but only when the results are not manipulated by call agent performance. However, by determining an agent performance indicator based on cost, a better picture of call agent performance can be viewed. In addition, the present invention allows for an assessment of the productive time of each call agent. Thus, idle time and training time, which might be necessary but are not what the call agent is hired to do, are not included in the productive time of each agent according to the present invention. Further, these productive hours could be used to calculate an equivalent force surplus.

Finally, when the cost based performance indicator is combined with use of exception reports, a supervisor is presented with a full picture that can allow him or her to make an informed and accurate judgment regarding the performance of individual call agents, call agent teams, the call center, and/or the call servicing system as a whole. As indicated, the present invention has the capability of linking the productivity analysis of individual call agents with the actual costs associated with the call agent function. As a result of this type of analysis, some call agents thought to be high performing role models when evaluated by AWT could, in fact, be identified as the highest cost call agents within the call servicing center. The power of a true performance measurement system based on standard units and directly linked to cost can change behaviors of call agents and drive desired performance. In addition, this invention could enable management to introduce valid ‘pay for performance’ systems. Further, the present invention could also enable supervisors to redirect much of their time now devoted to the collection and analysis of performance data to other, more important, tasks. For instance, management time could be utilized much more effectively in working with individual call agents and training call agents to correct specific problems.

It should be understood that the above description is intended for illustrative purposes only, and is not intended to limit the scope of the present invention in any way. Thus, those skilled in the art will appreciate that other aspects, objects and advantages of this invention can be obtained from a study of the drawings, the disclosure and the appended claims.

1. A method of evaluating call agent efficiency, comprising the steps of:
collecting agent call handling data for at least one call agent;
collecting agent cost data for said at least one call agent; and
determining a cost based performance indicator for said at least one call agent, at least in part as a function of said agent call handling data and said agent cost data.

2. The method of claim 1 wherein said step of determining a cost based performance indicator includes a step of determining a standard work time for said at least one call agent.

3. The method of claim 1 wherein said collecting steps include a step of collecting a sample of at least one of said agent call handling data and said agent cost data.

4. The method of claim 1 wherein said step of collecting agent call handling data includes at least one of a step of collecting agent service data, a step of collecting agent sales data and a step of collecting agent equivalent revenue data.

5. The method of claim 1 wherein said determining step includes a step of determining an individual cost based performance indicator for each said at least one call agent.

6. The method of claim 1 wherein said step of collecting agent cost data includes a step of retrieving said agent cost data from a preexisting database.

7. The method of claim 1 wherein said cost based performance indicator is an individual agent cost based performance indicator for each said at least one call agent; and
including a step of reporting each said individual agent cost based performance indicator to each said at least one call agent.

8. The method of claim 7 including a step of reporting an additional cost based performance indicator to each said at least one call agent.

9. The method of claim 8 wherein said at least one call agent includes a first call agent and a second call agent; and
said step of reporting an additional cost based performance indicator to each said at least one call agent includes a step of reporting a cost based performance indicator for said second call agent to said first call agent.

10. The method of claim 8 wherein said at least one call agent is a member of a call agent team; and
said step of reporting an additional cost based performance indicator to each said at least one call agent includes a step of reporting a cost based performance indicator for said call agent team to said at least one call agent.

11. The method of claim 1 including a step of determining a projected cost based performance indicator for said at least one call agent, in part by analyzing at least one of hypothetical agent call handling data and hypothetical agent cost data for said at least one call agent.

12. The method of claim 1 wherein said determining step includes a step of utilizing real-time agent call handling data and real time agent cost data to determine said cost based performance indicator.

13. The method of claim 1 including a step of generating at least one exception report based upon said agent call handling data.

14. A system for evaluating call agent efficiency comprising:
means for collecting agent call handling data for at least one call agent;
means for collecting agent cost data for said at least one call agent; and
means for determining a cost based performance indicator for said at least one call agent, wherein said cost based performance indicator is a function of said agent call handling data and said agent cost data.

15. The system of claim 14 wherein said means for collecting agent call handling data is a means for collecting a sample of said call handling data.

16. The system of claim 14 wherein at least one of said means for collecting agent cost data and said means for collecting agent call handling data is operably coupled to at least one pre-existing database.

17. The system of claim 14 wherein said cost based performance indicator is a standard work time for said at least one call agent.

18. The system of claim 14 including a means for reporting said cost based performance indicator.

19. The system of claim 18 wherein said means for reporting said cost based performance indicator includes a means for displaying a graphical representation of said cost based performance indicator.

20. The system of claim 18 wherein said at least one call agent is a member of a call agent team including at least one other call agent; and
said means for reporting said cost based performance indicator includes a means for reporting at least one of a cost based indicator for said call agent team and a cost based indicator for said at least one other call agent.

21. The system of claim 14 wherein said at least one call agent is a member of a call agent team and said cost based performance indicator is an individual cost based performance indicator for said at least one call agent.

22. The system of claim 21 including a means for determining a cost based performance indicator for said call agent team.

23. A method of evaluating call agent efficiency, comprising the steps of:
collecting agent call handling data for at least one call agent;
collecting agent cost data for said at least one call agent;
calculating a standard work time for said at least one call agent; and
determining a cost based performance indicator for said at least one call agent, at least in part as a function of said standard work time, said agent call handling data and said agent cost data.

24. The method of claim 23 wherein said step of collecting agent cost data includes a step of collecting a sample of available agent call handling data.

25. The method of claim 24 wherein said step of collecting agent call handling data includes at least one of a step of collecting agent service data, a step of collecting agent sales data and a step of collecting agent equivalent revenue data.

26. The method of claim 25 wherein said determining step includes a step of determining an individual cost based performance indicator for each said at least one call agent.

27. The method of claim 26 including a step of reporting each said individual agent cost based performance indicator to each said at least one call agent.

28. The method of claim 27 including a step of reporting an additional cost based performance indicator to each said at least one call agent.

29. The method of claim 28 wherein said at least one call agent is a member of a call agent team; and
including a step of determining a team cost based performance indicator, at least in part as a function of an amount of team call handling data and an amount of team cost data.

30. The method of claim 29 wherein said step of reporting said additional cost based performance indicator to each said at least one call agent includes a step of reporting at least one of said team cost based performance indicator and a cost based performance indicator of an other call agent to said at least one call agent.
